(19) United States
(12) Patent Application Publication
(10) Pub. No.: US 2017/0185172 A1
(43) Pub. Date: Jun. 29, 2017

(54) ELECTRONIC PEN

(71) Applicant: FUJI XEROX CO., LTD., Tokyo (JP)

(72) Inventors: Nobuhiro KITAGAWA, Kanagawa (JP); Eisuke OSAKABE, Kanagawa (JP); Koichi YOSHINO, Kanagawa (JP); Akihiko NAYA, Kanagawa (JP); Makoto AIHARA, Kanagawa (JP); Kenji MATSUKAWA, Kanagawa (JP); Shinichiro TANIGUCHI, Kanagawa (JP); Yasuaki KONISHI, Kanagawa (JP); Yoshinori YAMAGUCHI, Kanagawa (JP)

(73) Assignee: FUJI XEROX CO., LTD., Tokyo (JP)

(21) Appl. No.: 15/149,530

(22) Filed: May 9, 2016

(30) Foreign Application Priority Data
Dec. 28, 2015 (JP) 2015-256403

(51) Int. Cl. G06F 3/0354; B41J 2/175; G06F 3/03; G08B 5/36; G06F 3/038

(52) U.S. Cl. CPC G06F 3/03545; G08B 5/36; G06F 3/038; G06F 3/0304; B41J 2/17503

(57) ABSTRACT

Provided is an electronic pen including a rod-like member that includes a pen tip at a front and is supported movably in a longitudinal direction, an electronic component, at least a portion of which is provided on a rear side of the rod-like member opposite to a side on which the pen tip is included, a casing that has a tubular shape and stores the rod-like member and the electronic component, and a transmission member that is provided in a space interposed between the electronic component and an inner circumferential surface of the casing and transmits an externally received force at a rear of the rod-like member to move the rod-like member in the longitudinal direction.

### CROSS-REFERENCE TO RELATED APPLICATIONS

This application is based on and claims priority under 35 USC 119 from Japanese Patent Application No. 2015-256403 filed Dec. 28, 2015.

### BACKGROUND

(i) Technical Field

The present invention relates to an electronic pen.

(ii) Related Art

There has been known an electronic pen that reads a trajectory drawn by a user on a paper.

### SUMMARY

According to an aspect of the invention, there is provided an electronic pen including:

a rod-like member that includes a pen tip at a front and is supported movably in a longitudinal direction;

an electronic component, at least a portion of which is provided on a rear side of the rod-like member opposite to a side on which the pen tip is included;

a casing that has a tubular shape and stores the rod-like member and the electronic component; and

a transmission member that is provided in a space interposed between the electronic component and an inner circumferential surface of the casing and transmits an externally received force at a rear of the rod-like member to move the rod-like member in the longitudinal direction.

### BRIEF DESCRIPTION OF THE DRAWINGS

Exemplary embodiments of the present invention will be described in detail based on the following figures, wherein:

FIG. 1 is a diagram illustrating an entire configuration of an electronic pen system according to an example;

FIG. 2 is a diagram illustrating a coded image;

FIGS. 3A and 3B are diagrams illustrating a configuration of an electronic pen;

FIG. 4 is a diagram illustrating the electronic pen in a state where a USB terminal is connected;

FIG. 5 is a diagram illustrating a cross section of the electronic pen as viewed in the direction of an arrow C1-C1 in FIGS. 3A and 3B;

FIGS. 6A and 6B are diagrams illustrating the electronic pen in a state where a pen tip protrudes;

FIG. 7 is a diagram illustrating the electronic pen as viewed in a forward direction;

FIG. 8 is a diagram illustrating a rear end portion in a state where a cover is removed;

FIGS. 9A, 9B, and 9C are diagrams illustrating a stopper of a modification example;

FIGS. 10A, 10B, and 10C are diagrams illustrating aboard of the modification example;

FIG. 11 is a diagram illustrating a board included in an electronic pen of the modification example;

FIG. 12 is a diagram illustrating an electronic pen of the modification example; and

FIGS. 13A and 13B are diagrams illustrating examples of the electronic pen of the modification example.

### DETAILED DESCRIPTION

### [1] Example

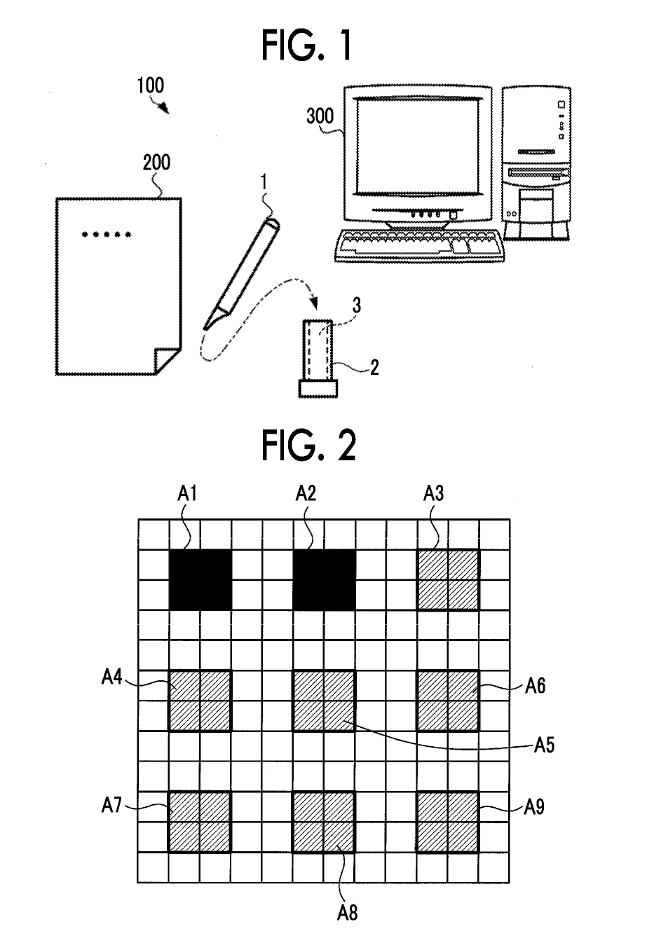

FIG. 1 illustrates an entire configuration of an electronic pen system 100 according to an example. The electronic pen system 100 includes an electronic pen 1, a cradle 2, a medium 200, and a personal computer (PC) 300. The electronic pen 1 realizes a function that allows a user to write characters, figures, and the like in handwriting on the medium 200 and a function of capturing a coded image that is formed on the medium 200. The coded image formed on the medium 200 is obtained by encoding and imaging information in accordance with a predetermined encoding scheme.

The cradle 2 is an electronic device that is electrically connected with the electronic pen 1 to mediate communication between the electronic pen 1 and an external apparatus or to supply power to the electronic pen 1. The cradle 2 includes a hole portion 3 into which the electronic pen 1 is inserted, and inserting the electronic pen 1 into the hole portion 3 provides an electrical connection between the cradle 2 and the electronic pen 1.

The medium 200 may be a paper or made of plastic, such as an OHP sheet, or any other materials or may be an electronic paper on which a display content is electrically rewritten. The PC 300 performs processing using decoded information if information is decoded from the coded image at a position specified by the electronic pen 1. The PC 300, for example, computerizes a written content that is handwritten by a user using the electronic pen 1 and generates electronic data that represents an electronic document.

FIG. 2 is a diagram illustrating the coded image. As illustrated in FIG. 2, the coded image is configured of a set of multiple point-like images. In FIG. 2, regions A1 and A2 that are rectangles illustrated in black correspond to regions in which the point-like images are arranged, and regions A3 to A9 that are hatched correspond to regions in which point-like images are not arranged. The coded image is an image that represents identification information used for identification of the medium 200 or position information indicating a position on the medium 200, and information is represented in accordance with an arrangement pattern of the point-like images.

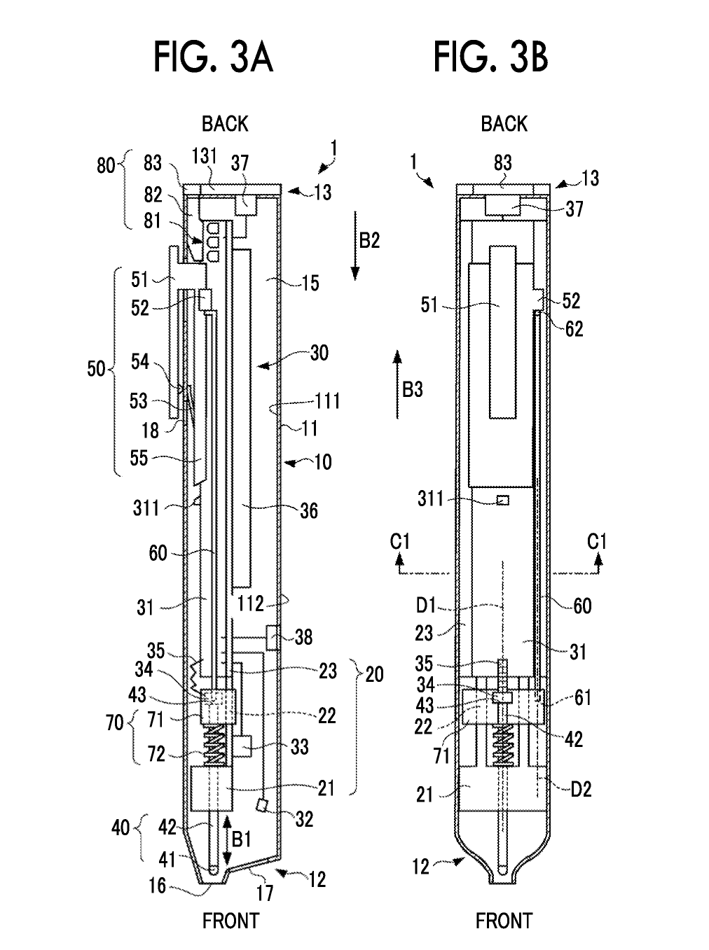

FIGS. 3A and 3B illustrate a configuration of the electronic pen 1. The electronic pen 1 illustrated in FIGS. 3A and 3B includes a casing 10, a frame 20, an electronic component group 30, a refill 40, a knock member 50, a shaft 60, a support member 70, and a state display device 80. FIG. 3A illustrates the electronic pen 1 with the knock member 50 viewed sidewise, and FIG. 3B illustrates the electronic pen 1 with the knock member 50 viewed from the front side. Aside of the electronic pen 1 to which a pen tip 41, described later, is attached will be referred to as a front side, and the opposite side thereto will be referred to as a back side. That is, the pen tip 41 is disposed on the front side of the electronic pen 1.

The casing 10 is a long member that includes a part having a tubular shape and is formed by using a non-metallic material (for example, a resin material). The casing 10 includes a cylinder portion 11 that has a cylindrical shape, a front end portion 12 that is formed at the front side of the cylinder portion 11 in a tapering shape and from which the pen tip 41 described later protrudes, and a rear end portion 13 that is disposed on the back side of the cylinder portion 11. An internal space 15 that has a circular columnar shape is formed on an inner circumferential surface 111 side of the cylinder portion 11. The internal space 15, that is, the inside of the casing 10, stores each portion included in the electronic pen 1. An opening 16 that serves as a passageway for the pen tip 41, described later, at the time of protrusion from the casing 10 and an opening 17 that serves as a passageway for light at the time of capturing the coded image are formed in the front end portion 12.

The frame 20 is a structure that is fixed to the casing 10 and supports the electronic component group 30. The frame 20 includes a fixed portion 21, a guide portion 22, and a support portion 23. The fixed portion 21 has the same size and the shape as the inner circumferential surface 111 of the cylinder portion 11 and is fixed to the inner circumferential surface 111 by bonding or the like. The guide portion 22 is shaped into two rods and supports a slider 71 included in the support member 70, described later, movably along these rods. The support portion 23 supports a board 31 and a battery 36 included in the electronic component group 30 described later.

The electronic component group 30 is multiple electronic components that are used in order for the electronic pen 1 to realize the function of capturing the coded image. An electronic component is a component used in a device that operates using electricity (electronic pen 1 in the present example). The electronic component group 30 includes the board 31, a light-emitting device 32, a capturing device 33, a pressure sensor 34, a flexible printed board 35, the battery 36, a UNIVERSAL SERIAL BUS (USB) terminal 37, and a cradle terminal 38.

The board 31 includes a calculation device including a central processing unit (CPU) or an application-specific integrated circuit (ASIC), a memory, and the like and, for example, manages a power supply of the electronic pen 1, controls driving of the light-emitting device 32 and the capturing device 33, captures the coded image, and transmits the captured coded image to the PC 300. The board 31 includes a start switch 311. Pressing the start switch 311 supplies power from the battery 36 or an external power supply to the board 31 and supplies power to other units through the board 31.

The light-emitting device 32 includes a light source such as a light-emitting diode (LED) and emits light (infrared light in the present example) emitted by the light source in the direction toward the opening 17. The capturing device 33 includes a lens, an aperture stop, a reflector, an image sensor, and the like and captures a subject (for example, the coded image) by receiving light that is incident from the opening 17.

The pressure sensor 34 measures a force at which the pen tip 41, described later, is pressed. The force at which the pen tip 41 is pressed corresponds to a pressure that is applied to the pen tip 41 pressed to the medium at the time of writing using the electronic pen 1, that is, a pen pressure. The flexible printed board 35 is a board that maintains electrical characteristics thereof under repeated deformation and electrically connects the board 31 with the pressure sensor 34. The battery 36 is, for example, a rechargeable battery and supplies power used for driving of the electronic pen 1 to each unit of the electronic pen 1.

The USB terminal 37 is a female-type terminal that complies with the USB standard and is disposed in the rear end portion 13 of the casing 10 and electrically connected with the board 31. The USB terminal 37 is an example of “terminal” and “first terminal” of the present invention. If a male-type USB terminal is inserted into the USB terminal 37, the USB terminal 37 electrically connects an external apparatus that is connected thereto through the male-type USB terminal with the board 31. Accordingly, the external apparatus communicates with the board 31, or power that is supplied from the external apparatus is supplied to the board 31.

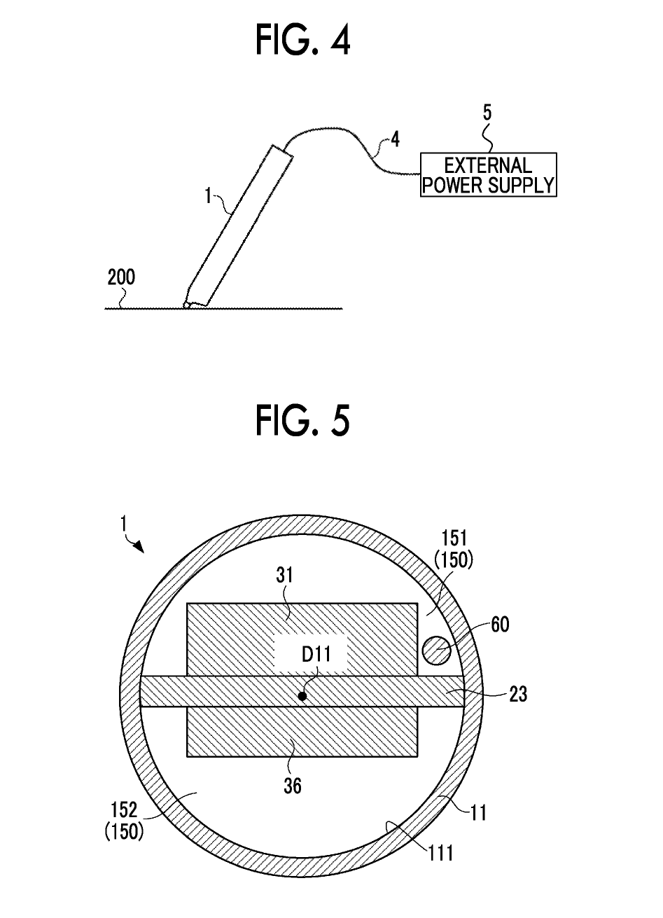

FIG. 4 illustrates the electronic pen 1 in a state where the USB terminal 37 is connected. In FIG. 4, a USB cable 4 that includes a USB terminal is connected to the rear end portion 13 of the electronic pen 1, and an external power supply 5 is connected to the other end of the USB cable 4. Since the USB cable is not positioned in the cylinder portion 11 or the front end portion 12 of the electronic pen 1 that the user holds at the time of writing, writing may be performed along with supply of power to the electronic pen 1. The terminal that is disposed in the rear end portion 13 of the electronic pen 1 is not limited to a USB terminal, and a MICRO-USB terminal, a dedicated terminal for the electronic pen 1, or the like may be disposed therein.

The cradle terminal 38 is a terminal that is disposed in the cylinder portion 11, which is at a different position from the rear end portion 13 of the casing 10, and is electrically connected with the board 31. The cradle terminal 38 is an example of “second terminal” of the present invention. The cradle terminal 38 is in contact with an electrode of the cradle 2 in a state where the electronic pen 1 is inserted into the cradle 2 and electrically connects the board 31 with the cradle 2. Accordingly, an external apparatus and the board 31 that are connected through the cradle 2 communicate with each other, or power that is supplied from the external apparatus is supplied to the board 31.

As such, the electronic pen 1 is supplied with power through two types of terminals. In either case where power is supplied to the board 31 through the USB terminal 37 or the cradle terminal 38, the board 31 operates itself and each unit by the supplied power and recharges the battery 36. Connection to the cradle terminal 38 is simply made by inserting the electronic pen 1 into the cradle 2 and thus is easier than connection to the USB terminal 37. Meanwhile, connection to the USB terminal 37 allows writing along with supply of power as described with FIG. 4 even if the battery 36 is empty. As such, providing two types of terminals increases convenience of use as compared with a case where there is one type of terminal.

The refill 40 is a so-called lead refill and is removable from the electronic pen 1 and replaceable by another refill 40. The refill 40 is a straight rod-like member and is an example of “rod-like member” of the present invention. The refill 40 is movably supported by the support member 70, described later, in a longitudinal direction B1 indicated by an arrow in FIG. 3A. The longitudinal direction B1 is a direction along the length of the rod-like refill 40.

The refill 40 includes the pen tip 41 on the front side thereof and an ink storing section 42 at the back side of the pen tip 41. The ink storing section 42 is shaped into a rotating body (specifically, a cylinder) having an axis D1 extending in the longitudinal direction B1 and stores ink to be supplied to the pen tip 41 in the inside of a hollow. In FIGS. 3A and 3B, the pen tip 41 is drawn back into the casing 10. If the pen tip 41 moves in a forward direction B2 (direction toward the front in the longitudinal direction B1) from the rear of the electronic pen 1 toward the front thereof and protrudes from the casing 10, a writing motion is performed by pressing the pen tip 41 to the medium, and characters or patterns are drawn by discharging ink from the pen tip 41.

A space in which at least a part of the electronic components included in the electronic component group 30 may be arranged exists on the rear side of the refill 40 (that is, the side opposite to the pen tip 41 side) (hereinafter, the space will be referred to as “refill rearward space”). The refill rearward space is a space that exists in the longitudinal direction B1 of the refill 40 and is a space that has the same dimension in the width direction thereof as the dimension in the width direction of the refill 40. More specifically, the refill rearward space is a circular columnar space having a boundary corresponding to an imaginary plane obtained by extending the outer circumferential surface of the ink storing section 42 of the refill 40 rearwardly. The board 31 (strictly, a part of the board 31) is arranged in this refill rearward space in the electronic pen 1.

The knock member 50 is a member to which a force used for protrusion of the pen tip 41 outside of the casing 10 is applied. The knock member 50 is brought into contact with an external object (for example, a finger of the user) at the rear of the refill 40 and receives a force from the object. The knock member 50 includes a knock unit 51, a shaft hook unit 52, a stopper 53, a stopper releasing unit 54, and a switch pressing unit 55.

The knock unit 51 is a part of the knock member 50 at which a knock operation (operation of knocking the knock unit 51) that is an operation for initiation of writing with the electronic pen 1 is performed. The knock unit 51 is arranged outside of an outer circumferential surface 112 of the casing 10 and brought into contact with an external object and receives a force from the object. Specifically, a forward force of the electronic pen 1 is applied to the knock unit 51 from the finger of the user who performs the knock operation. The knock unit 51 is an example of “contact member” of the present invention. The shaft hook unit 52 is formed to be hooked at the rear end of the shaft 60, described later, and transmits the force applied to the knock unit 51 to the shaft 60.

The stopper 53 causes the knock member 50 that is moved in the forward direction B2 by the force applied to the knock unit 51 to stop at a certain position. The stopper releasing unit 54 releases the state where the knock member 50 is caused to stop at a certain position by the stopper 53. If the state is released, the knock member 50 is moved in a rearward direction B3 (direction toward the back side in the longitudinal direction B1) and returns to an original position thereof. The switch pressing unit 55 presses the start switch 311 included in the board 31 if the switch pressing unit 55 is moved forwardly by the force applied to the knock unit 51. These units will be described in detail below with reference to other drawings.

The shaft 60 is an elongated rod-like member that is formed of steel use stainless (SUS) in the present example. More specifically, the shaft 60 is an elongated circular columnar member and is formed to have a smaller diameter than the ink storing section 42 of the refill 40. The shaft 60 is arranged to have an axis that is shifted from the axis D1 of the ink storing section 42 (an axis D2 of the shaft 60 is separated from the axis D1). Furthermore, the shaft 60 is arranged in a space of the internal space 15 of the casing 10 that is interposed between the board 31 and the inner circumferential surface 111 of the cylinder portion 11 of the casing 10. This space will be described with reference to FIG. 5.

FIG. 5 illustrates a cross section of the electronic pen 1 as viewed in the direction of an arrow C1-C1 in FIGS. 3A and 3B. FIG. 5 illustrates gaps 151 and 152 (referred to as “gap 150” unless distinguished particularly) that are spaces interposed between the inner circumferential surface 111 of the cylinder portion 11 and the board 31. The gap 150 is a part of the internal space 15 of the casing 10. The gap 150 includes not only the gap 151 in which other objects excluding the shaft 60 do not exist between the inner circumferential surface 111 and the board 31 but also the gap 152 in which the support portion 23 and the battery 36 exist between the inner circumferential surface 111 and the board 31. The shaft 60 is arranged in the gap 151 in the present example.

The shaft 60 is arranged at a position closer to the inner circumferential surface 111 than an axis D11 of the cylinder portion 11. In order to approximately replicate the experience of writing with a typical pen, the refill 40 is likely to be arranged as close as possible to the axis D11. Since there is a very small volume of space around the axis D11 due to a concentration of the frame 20, the electronic component group 30, and the like, a sufficient space may not be secured. Meanwhile, a space close to the inner circumferential surface 111 has a larger volume than the space around the axis D11, and there are almost no electronic components having a shape along the inner circumferential surface 111. Thus, a gap is likely to be generated. Arranging the shaft 60 as described above facilitates securing a space for arrangement of the shaft 60 as compared with a case of arranging the shaft 60 close to the axis D11 and facilitates designing arrangement or shapes of the frame 20 and the electronic component group 30.

The SUS that the shaft 60 is formed of is a conductor. In the electronic pen 1, the shaft 60 which is a conductor is arranged at a position close to the casing 10 as illustrated in FIG. 5. Meanwhile, a part in the longitudinal direction B1 of the casing 10 at which the shaft 60 is arranged, that is, the cylinder portion 11, is formed by a single member in a cylindrical shape. The single member means that the cylinder portion 11 is originally formed as a cylindrical member without forming the cylindrical shape thereof by bonding or the like of two or more members. Thus, as compared with a case of forming the cylinder portion 11 by multiple members, external electricity is unlikely to enter the internal space 15, and problems caused by transmission of electricity to the electronic components such as the board 31 through the shaft 60 are unlikely to arise.

FIGS. 3A and 3B are referred to again. The shaft 60 transmits an external force received at the rear of the refill 40 (external force received by the knock member 50) and moves the refill 40 in the longitudinal direction B1. The shaft 60 is an example of “transmission member” of the present invention. If a forward force is applied to the knock member 50, the force is transmitted from the shaft hook unit 52 to the shaft 60, and the shaft 60 is moved forwardly. A front end 61 of the shaft 60 is fixed to the support member 70.

The support member 70 is a member to which the refill 40 is fixed and that moves under the guidance of the frame 20 to support the refill 40 movably in the longitudinal direction B1. The support member 70 includes the slider 71 and a spring 72. The slider 71 includes holes that pass the guide portion 22 (two rods) included in the frame 20. The slider 71 is moved in the longitudinal direction B1 by passing of the guide portion 22 through the holes.

As such, using the frame 20 as a guide facilitates decreasing the size of the casing as compared with disposing a member serving as a guide in addition to the frame 20. A rear end 43 of the refill 40 and the front end 61 of the shaft 60 are fixed to the slider 71. Thus, if the shaft 60 moves forwardly, the slider 71 moves forwardly, and consequently, the refill 40 also moves forwardly.

The pressure sensor 34 is disposed in the slider 71. The pressure sensor 34 is disposed at a position that is in contact with the rear end 43 of the refill 40. Thus, if the pen tip 41 of the refill 40 is pressed to the medium, a reaction force that is generated from the medium in response to the pressure (pen pressure) applied by the pen tip 41 to the medium is transmitted to the pressure sensor 34 through the refill 40 and is measured as a pressure. As described above, the refill 40 is fixed to the slider 71. However, if the pen pressure is applied, the refill 40 is moved to the extent corresponding to the extent of the pressure that is applied to the pressure sensor 34 by deformation of a member fixing the refill 40.

The spring 72 has a front end thereof in contact with the fixed portion 21 of the frame 20 and is not moved forwardly beyond the point of contact. In addition, the spring 72 has a rear end thereof in contact with the slider 71 and applies a rearward force to the slider 71. Accordingly, the refill 40 does not extend out of the electronic pen 1 even if the front side of the electronic pen 1 is directed in a vertically downward direction. In addition, if a force applied to the knock member 50 moves the shaft 60 and the support member 70 forwardly and causes the pen tip 41 of the refill 40 to protrude from the casing 10, the spring 72 that applies a rearward force presses the stopper 53 to the casing 10.

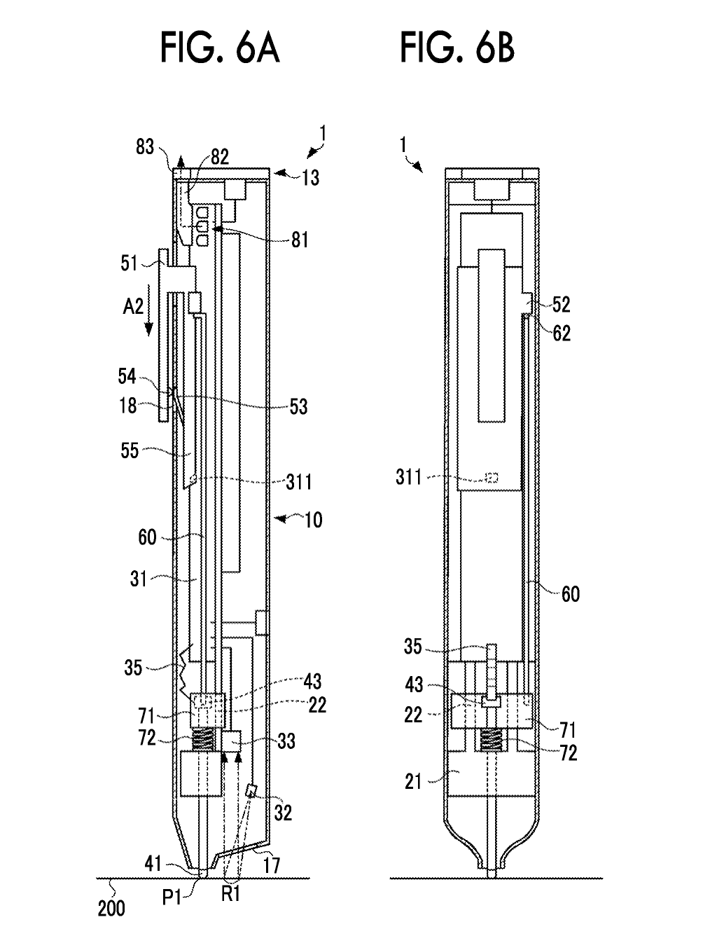

FIGS. 6A and 6B illustrate the electronic pen 1 in a state where the pen tip 41 protrudes. An opening 18 is formed at a position corresponding to the stopper 53 of the casing 10. The stopper 53 is put into the opening 18 if moved forwardly and is pressed to the casing 10 at the rear of the opening 18 by the force received from the spring 72 through the support member 70 and the shaft 60. In this state, the knock member 50, the shaft 60, the support member 70, and the refill 40 are not moved rearwardly beyond the current positions thereof and stop. The pen tip 41 stops in a protruding state without returning to the inside of the casing 10.

In the state illustrated in FIGS. 6A and 6B, if the front side of the knock unit 51 is pressed by the user toward the casing 10, the stopper releasing unit 54 that is disposed at a position facing the stopper 53 pushes back the stopper 53 into the casing 10. Then, the knock member 50 that includes the stopper 53 is placed into a state movable rearwardly by the force received from the spring 72. Thus, the knock member 50, the shaft 60, the support member 70, and the refill 40 are moved rearwardly, the stopper 53 is stored in the casing 10, and the pen tip 41 is stored in the casing 10.

As illustrated in FIGS. 6A and 6B, if the knock member 50 is moved forwardly, the switch pressing unit 55 presses the start switch 311 disposed in the board 31. In other words, the start switch 311 is disposed at a position that is pressed by the switch pressing unit 55 when the knock member 50 is moved forwardly. Accordingly, if the user moves the knock member 50 forwardly and causes the pen tip 41 to protrude, power is supplied to each of the electronic components included in the electronic component group 30.

The pressure sensor 34 is supplied with power through the flexible printed board 35. A signal from the pressure sensor 34 is transmitted to the board 31 through the flexible printed board 35. The flexible printed board 35 has a length corresponding to the distance of movement of the support member 70 and maintains the electrical connection between the board 31 and the pressure sensor 34 even if the pressure sensor 34 disposed in the support member 70 is moved.

FIGS. 6A and 6B illustrate a state where the pen tip 41 is pressed to the medium 200. In this state, the pressure sensor 34 measures a pen pressure, and the value of the pen pressure measured is supplied to the board 31 through the flexible printed board 35. If the pen pressure measured is, for example, greater than or equal to a threshold, the board 31 performs a control that drives the light-emitting device 32 and the capturing device 33. Accordingly, the infrared light emitted by the light-emitting device 32 reaches a region R of the medium 200 through the opening 17, and the infrared light that is diffusively reflected by the region R (diffusively reflected light) reaches the capturing device 33. This diffusively reflected light represents the coded image formed in the region R.

The region R is a region at a position that corresponds to a contact position P1 at which the pen tip 41 is in contact with the medium 200. Specifically, the region R exists at a position that is separated by the distance between the refill 40 and the capturing device 33 from the contact position P1 in the direction from the refill 40 toward the capturing device 33. The capturing device 33 is a sensor that reads light from the region R and captures the coded image represented by the read light (diffusively reflected light).

The capturing device 33 performs the capturing at a predetermined frame rate (for example, 60 fps (frames per second)). The board 31 decodes information represented by the coded image from the captured coded image and extracts the identification information and the position information. This extraction may use a known technology, and, for example, the technology disclosed in JP-A-2013-152705 is used. The board 31 transmits the extracted information to the PC 300.

FIGS. 3A and 3B are referred to again. The state display device 80 displays the state of the electronic pen 1. The state display device 80 displays, for example, the state where the pressure sensor 34 measures a pen pressure that is greater than or equal to the threshold and the light-emitting device 32 and the capturing device 33 are driven to capture the coded image. The state display device 80 includes a light-emitting body group 81, an optical system 82, and a display window 83. The light-emitting body group 81 is multiple light-emitting bodies that emit visible light and is, for example, multiple LEDs. Each light-emitting body is electrically connected to the board 31.

The optical system 82 includes a mirror and the like and guides the light emitted by the light-emitting body group 81 to the display window 83. The display window 83 displays the light that reaches the display window 83 through the optical system 82. The display window 83 is disposed in the rear end portion 13 of the casing 10 and is formed by a member that transmits light. The board 31 causes corresponding light-emitting bodies to emit light, for example, in a start state where the start switch 311 of the board 31 is pressed, in a pen pressure detection state where the pressure sensor 34 measures a pen pressure greater than or equal to the threshold, and in an external power supply state where the USB terminal 37 or the cradle terminal 38 is connected and power is supplied from the external power supply. The light emitted by the light-emitting bodies passes the optical system 82 and is output from the display window 83.

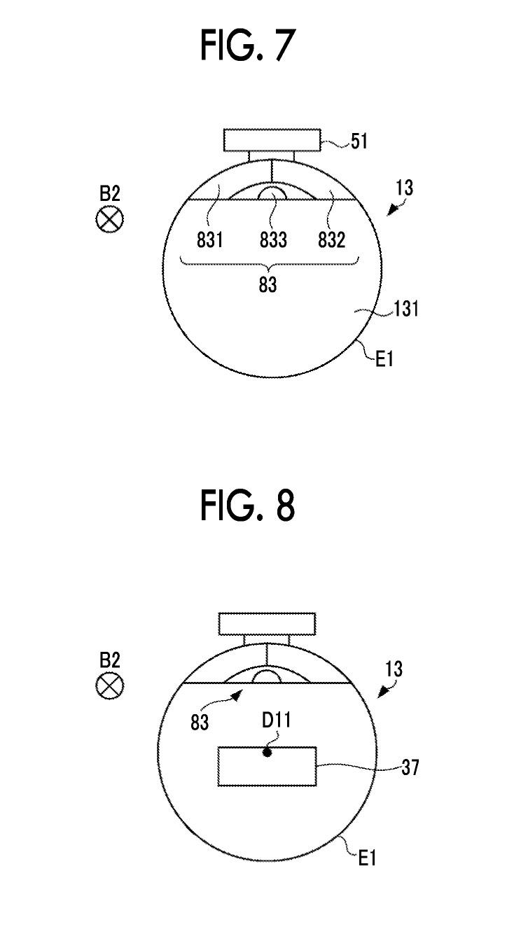

FIG. 7 illustrates the electronic pen 1 as viewed in the forward direction B2. The display window 83 includes a first window 831, a second window 832, and a third window 833. Light from each light-emitting body is output from each window. For example, light is output from the first window 831 in the start state. Light is output from the second window 832 in the pen pressure detection state. Light is output from the third window 833 in the external power supply state. As such, the state display device 80 illustrated in FIGS. 6A and 6B and the like causes emission of light from the rear end portion 13 in the start state, that is, when the electronic pen 1 operates, and in the external power supply state, that is, when the battery 36 is recharged.

In the pen pressure detection state, the state display device 80 causes emission of light from the rear end portion 13 when the capturing device 33 reads light from the region R, since the light-emitting device 32 and the capturing device 33 are driven in that state. The state display device 80 is an example of “light-emitting unit” of the present invention. This emission of light allows the user to recognize the state where the written content is computerized. When the user writes on the medium 200 with the electronic pen 1, the eyes of the user are usually further away from the medium 200 than the rear end portion 13. Thus, the state display device 80 causing the rear end portion 13 to emit light allows the user to easily recognize the computerization state (state where the capturing device 33 reads light) as compared with a case of causing a position other than the rear end portion 13 to emit light.

A cover 131 of the USB terminal 37 is disposed in the rear end portion 13. Removing the cover 131 exposes the USB terminal 37 in the rear end portion 13.

FIG. 8 illustrates the rear end portion 13 in a state where the cover 131 is removed. The USB terminal 37 is disposed in a region from which the state display device 80 causes emission of light, that is, a region closer to the center of the rear end portion 13 than the display window 83. The center of the rear end portion 13 is a position in the rear end portion 13 that intersects with the axis D11 of the cylinder portion 11 of the casing 10 illustrated in FIGS. 3A and 3B. On the contrary, the display window 83 is disposed closer to an edge E1 of the rear end portion 13 than the USB terminal 37.

FIG. 7 is referred to again. The state display device 80 causes emission of light from a region that is closer to the edge E1 of the rear end portion 13 than the USB terminal 37. More specifically, the state display device 80 causes emission of light from a region that includes a part of the edge E1 closest to the knock unit 51 of the knock member 50. If the user faces the knock unit 51 in a case of applying a force to the knock unit 51, the user easily performs the knock operation as compared with a case of facing the opposite side. The state display device 80 causes emission of light from a region that is likely to be seen by the user when the user holds the electronic pen 1 facing the knock unit 51.

As described heretofore, in the present example, the shaft 60 that is arranged in the space interposed between the board 31, which is arranged in the refill rearward space, and the inner circumferential surface 111 of the casing 10 moves the refill 40 in the longitudinal direction B1. If a member that transmits an externally received force is arranged in the refill rearward space, the board 31 has to be arranged to be shifted from the refill rearward space, and a casing that is larger than the casing 10 is required. In addition, if not only the board 31 but also other electronic components are not arranged in the refill rearward space due to the member that transmits a force, a casing that is larger than the casing 10 is required. As compared with these cases, the shaft 60 transmits a force in the electronic pen 1. Thus, the board 31 (at least apart thereof) is arranged in the refill rearward space, and a narrow casing may be used.

### [2] Modification Examples

The above example is merely an example of exemplary embodiment of the present invention and may be modified as follows. In addition, the example and each modification example may be combined if necessary.

### [2-1] Stopping at Multiple Positions

While the stopper 53 causes the refill 40 and the knock member 50 to stop at one position in the example, the refill 40 and the knock member 50 may stop at multiple positions.

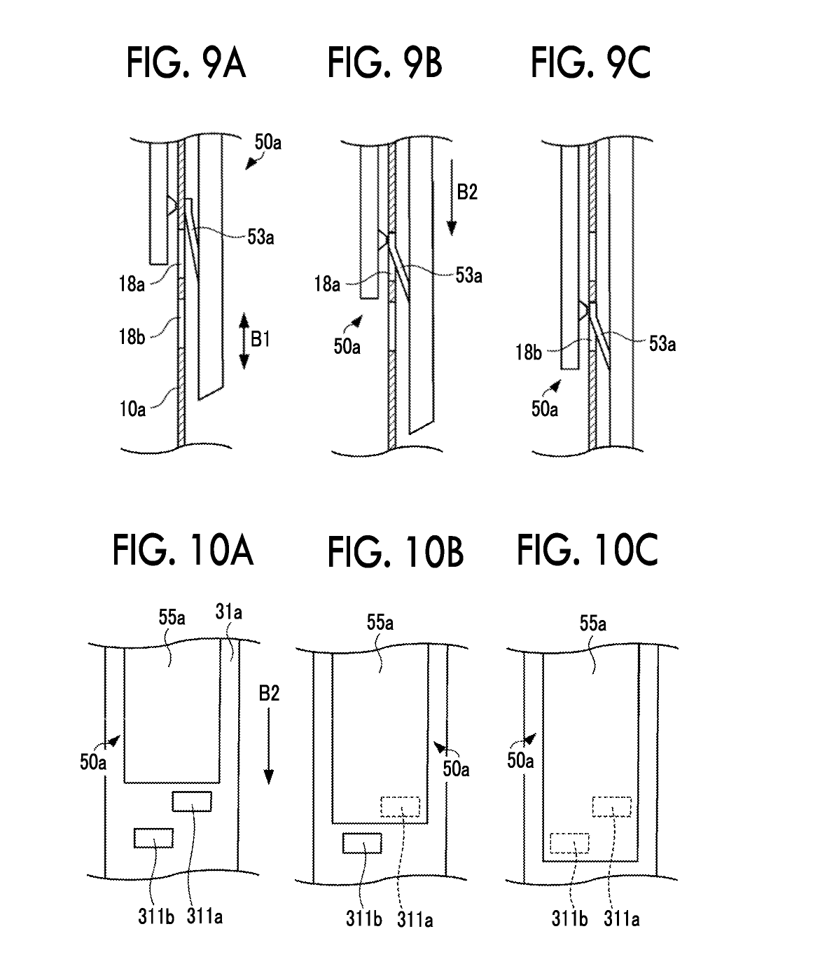

FIGS. 9A to 9C illustrate a stopper 53a of the present modification example. The stopper 53a causes the refill 40 (not illustrated) and a knock member 50a that are moved in the longitudinal direction B1 to stop at certain multiple positions. An opening 18a and an opening 18b are disposed in a casing 10a of the present modification example linearly in the longitudinal direction B1 of the refill 40. In FIG. 9A, the stopper 53a is stored in the casing 10a.

If a force is applied to the knock unit 51 in the forward direction B2, the stopper 53a is moved in the forward direction B2 as illustrated in FIG. 9B and put into the opening 18a and causes the knock member 50a to stop at this position (referred to as “first position”). In this state, if a force is further applied to the knock unit 51 in the forward direction B2, the stopper 53a is further moved in the forward direction B2 as illustrated in FIG. 9C and put into the opening 18b and causes the knock member 50a to stop at this position (referred to as “second position”). As such, the stopper 53a causes the knock member 50a to stop at multiple positions (the first position and the second position).

A board includes multiple switches in the present modification example.

FIGS. 10A to 10C illustrate a board 31a of the present modification example. The board 31a includes a first switch 311a and a second switch 311b. For example, the first switch 311a is a switch that starts the board 31a, and the second switch 311b is a switch that changes an operational mode of the board 31a. As illustrated in FIG. 10A, neither of the switches is pressed before movement of the knock member 50a.

If the knock member 50a stops at the first position illustrated in FIG. 9B, a switch pressing unit 55a presses the first switch 311a and causes the board 31a to be started. If the knock member 50a stops at the second position illustrated in FIG. 9C, the switch pressing unit 55a presses the second switch 311b and causes the operational mode of the board 31a to be changed. As such, the board 31a operates according to the position at which the refill 40 stops. Accordingly, multiple types of operations are performed by the board 31a.

### [2-2] Shape and Arrangement of Board

The shape and arrangement of a board are not limited to those described in the example.

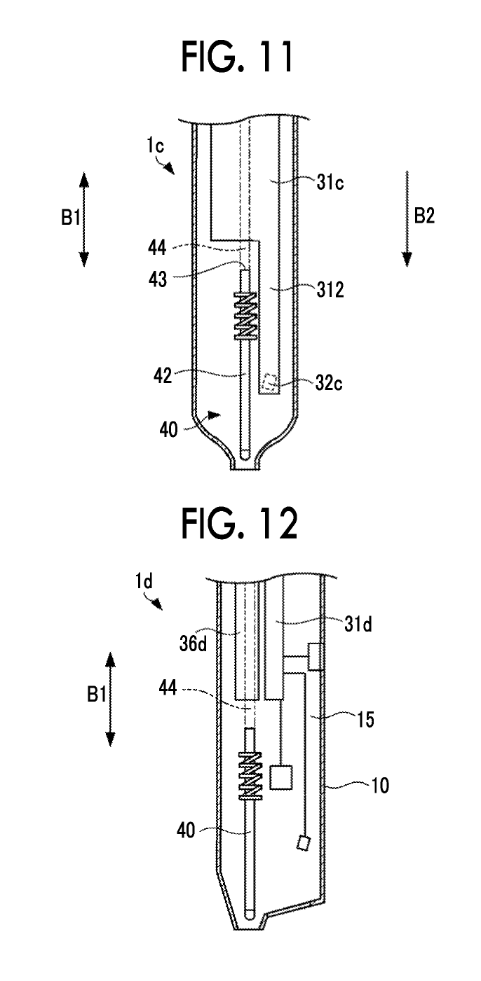

FIG. 11 illustrates a board 31c included in an electronic pen 1c of the present modification example. A refill rearward space 44 is illustrated in FIG. 11. The board 31c includes an extending portion 312 that extends to a position at which a light-emitting device 32c is arranged, and the light-emitting device 32c is mounted on the tip end of the extending portion 312. Thus, the board 31c is said to be arranged from the rear side of the rear end 43 of the refill 40 to the front side of the rear end 43. In this case, at least a part of the board 31c is arranged in the refill rearward space 44. Since a part of the board 31c is arranged in the refill rearward space 44, a narrow casing may be used as compared with a case of arranging the member that transmits an externally received force, described in the example, in the refill rearward space 44 (that is, a case where the board 31c is not arranged in the refill rearward space 44).

### [2-3] Arrangement of Electronic Components

While a board is arranged in the refill rearward space in the above example, the present invention is not limited thereto, and other electronic components may be arranged therein.

FIG. 12 illustrates an electronic pen 1d of the present modification example. In the electronic pen 1d, a battery 36d is arranged in the refill rearward space 44, described with FIG. 11, and a board 31d is arranged in a space other than the refill rearward space 44 in the internal space 15 of the casing 10.

In this case, since an electronic component such as the battery 36d is arranged in the refill rearward space 44, a narrow casing may be used as compared with a case of arranging the member that transmits an externally received force in the refill rearward space 44. As such, any electronic component may be arranged in the refill rearward space.

### [2-4] Transmission Member

A transmission member that transmits an externally received force at the rear of the refill 40 to move the refill 40 in the longitudinal direction B1 is not limited to the shaft 60 described in the example.

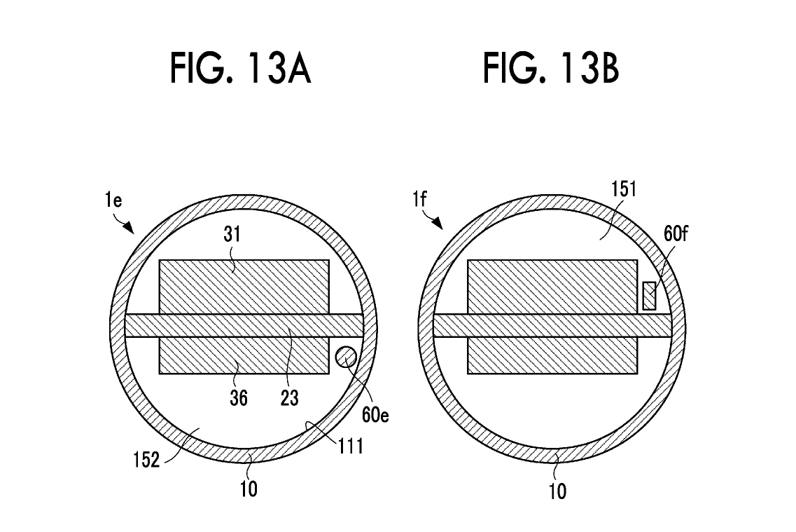

FIGS. 13A and 13B illustrate examples of the electronic pen of the present modification example. FIG. 13A illustrates an electronic pen 1e that includes a shaft 60e arranged in the gap 152 (a space that is interposed between the inner circumferential surface 111 and the board 31 and in which the support portion 23 and the battery 36 exist).

FIG. 13B illustrates an electronic pen if in which a plate-shaped member 60f having a plate shape is arranged as the transmission member in the gap 151. All of these electronic pens are arranged in a space (gap 151 or 152) that is interposed between an electronic component (board 31) and the inner circumferential surface 111 of the casing 10 and include the shaft 60e and the plate-shaped member 60f as the transmission member that transmits an externally received force at the rear of the refill 40, not illustrated, to move the refill 40 in the longitudinal direction B1 illustrated in FIGS. 3A and 3B and the like.

Accordingly, the board 31 that is arranged at the rear of the refill 40 in the longitudinal direction B1 is not required to be shifted. Thus, a narrow casing is used as compared with a case of arranging the member that transmits an externally received force on the rear side in the longitudinal direction B1 of the refill 40 (refill rearward space). While the shaft 60 described in the example is a conductor, the present invention is not limited thereto, and the shaft 60 may be a non-conductor. The point is that a transmission member made of any material in any shape may be used, provided that the transmission member has strength capable of transmitting an externally received force to move the refill 40.

### [2-5] Rod-Like Member

A rod-like member that includes a pen tip at the front thereof is not limited to the refill 40 described in the example. For example, the size of the ink storing section may be changed, or a pencil lead refill may be stored instead of ink as a mechanical pencil. The rod-like member may be a stylus pen if, for example, an electronic paper is used as a medium. The rod-like member may be a member that is fixed to the electronic pen and not replaced. The point is that any member may be used as the rod-like member, provided that the member is a rod-like member that includes a pen tip at the front thereof and is supported movably in the longitudinal direction thereof.

### [2-6] Casing

A casing is not limited to the casing described in the example. For example, the casing may be in a cylindrical shape as the cylinder portion 11 illustrated in FIGS. 3A and 3B and the like, or a tubular casing that is hollow and has a triangular or quadrangular shape may be used. The point is that any member may be used as the casing, provided that the member is a tubular member that forms an internal space in which the rod-like member and electronic components are stored.

### [2-7] Refill Rearward Space

A refill rearward space, that is, a space in which at least a part of the electronic components may be arranged, is not limited to the refill rearward space described above. For example, the refill rearward space may be a space that has a dimension in the width direction thereof larger or smaller than the dimension in the width direction of a refill, provided that the refill rearward space is a space that exists in the longitudinal direction B1 on the rear side of the refill. More specifically, the refill rearward space may be a space on the rear side of the refill.

In the electronic pen, in a case of using the former refill rearward space, at least a part of the electronic components is arranged in the longitudinal direction B1 on the rear side of the refill, or in a case of using the latter refill rearward space, at least a part of the electronic components is arranged on the rear side of the refill. The point is that the dimension in the width direction of the refill rearward space may not be limited to the dimension in the width direction of the refill. The reason is that even if such a limitation is not placed, electronic components are arranged in the refill rearward space, and thus, a narrow casing may be used as compared with a case of not arranging electronic components in the refill rearward space.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic pen comprising:
a rod-like member that includes a pen tip at a front and is supported movably in a longitudinal direction;
an electronic component, at least a portion of which is provided on a rear side of the rod-like member opposite to a side on which the pen tip is included;
a casing that has a tubular shape and stores the rod-like member and the electronic component; and
a transmission member that is provided in a space interposed between the electronic component and an inner circumferential surface of the casing and transmits an externally received force at a rear of the rod-like member to move the rod-like member in the longitudinal direction.

2. The electronic pen according to claim 1,
wherein the rod-like member includes a rotating body portion that has a shape of a rotating body having an axis extending in the longitudinal direction, and
the transmission member is a shaft that is provided to have an axis shifted from the axis of the rotating body portion.

3. The electronic pen according to claim 2,
wherein the shaft is formed of a conductor, and
at least a portion of the casing at which the shaft is provided is formed of a single member.

4. The electronic pen according to claim 1, further comprising:
a frame that is fixed to the casing and supports the electronic component; and
a support member to which the rod-like member is fixed and that moves under guidance of the frame to support the rod-like member movably in the longitudinal direction.

5. The electronic pen according to claim 2, further comprising:
a frame that is fixed to the casing and supports the electronic component; and
a support member to which the rod-like member is fixed and that moves under guidance of the frame to support the rod-like member movably in the longitudinal direction.

6. The electronic pen according to claim 3, further comprising:
a frame that is fixed to the casing and supports the electronic component; and
a support member to which the rod-like member is fixed and that moves under guidance of the frame to support the rod-like member movably in the longitudinal direction.

7. The electronic pen according to claim 4, further comprising:
a pressure sensor that is provided in the support member and measures a force by which the pen tip is pressed; and
a flexible printed board that electrically connects the electronic component with the pressure sensor and has a length corresponding to a distance by which the support member moves.

8. The electronic pen according to claim 5, further comprising:
a pressure sensor that is provided in the support member and measures a force by which the pen tip is pressed; and
a flexible printed board that electrically connects the electronic component with the pressure sensor and has a length corresponding to a distance by which the support member moves.

9. The electronic pen according to claim 6, further comprising:
a pressure sensor that is provided in the support member and measures a force by which the pen tip is pressed; and
a flexible printed board that electrically connects the electronic component with the pressure sensor and has a length corresponding to a distance by which the support member moves.

10. The electronic pen according to claim 1, further comprising:
a stopper that causes the rod-like member which is moved in the longitudinal direction to stop at a plurality of certain positions,
wherein the electronic component operates according to the position at which the rod-like member stops.

11. The electronic pen according to claim 1, further comprising:
a sensor that reads light from a position corresponding to a position at which the pen tip is in contact with a medium; and
a light-emitting unit that causes emission of light from a rear end portion of the electronic pen when the sensor reads the light.

12. The electronic pen according to claim 11, further comprising:
a terminal that is provided in the rear end portion of the electronic pen and electrically connected with the electronic component, the terminal being provided closer to a center of the rear end portion viewed in the longitudinal direction than a region from which the light-emitting unit causes emission of light.

13. The electronic pen according to claim 11, further comprising:
a contact member that is provided outside of an outer circumferential surface of the casing and comes into contact with an external object and receives a force from the object,
wherein the casing has a tubular shape, and
the light-emitting unit causes emission of light from a region that includes a portion of the rear end portion of the electronic pen which is closest to the contact member.

14. The electronic pen according to claim 12, further comprising:
a contact member that is provided outside of an outer circumferential surface of the casing and comes into contact with an external object and receives a force from the object,
wherein the casing has a tubular shape, and
the light-emitting unit causes emission of light from a region that includes a portion of the rear end portion of the electronic pen which is closest to the contact member.

15. The electronic pen according to claim 1, further comprising:
a first terminal that is electrically connected with the electronic component and is provided in a pen rear end portion which is an end portion of the electronic pen on the opposite side to the pen tip; and
a second terminal that is electrically connected with the electronic component and is provided at a position different from the pen rear end portion.
